(19) United States
(12) Patent Application Publication
(10) Pub. No.: US 2007/0237273 A1
(43) Pub. Date: Oct. 11, 2007

(54) Complex filter with automatic tuning capabilities

(76) Inventors: Seeteck Tan, Singapore (SG); Du Dingkun, Beijing (CN); Li Yongming, Beijing (CN)

Correspondence Address: CARLTON FIELDS, PA, 1201 WEST PEACHTREE STREET, 3000 ONE ATLANTIC CENTER, ATLANTA, GA, 30309, US

(21) Appl. No.: 11/436,165

(22) Filed: May 17, 2006

Related U.S. Application Data
(60) Provisional application No. 60/778,222, filed on Mar. 2, 2006.

(51) Int. Cl. H04B 1/10

(52) U.S. Cl. 375/350

(57) ABSTRACT

A complex filter with automatic tuning capabilities for filtering a complex signal is disclosed. The complex filter includes a first lowpass filter, a second lowpass filter, a plurality of resistors, an integrator, a comparator, and a digital unit. The complex filter includes an imaginary component and a real component. The integrator, the comparator and the digital unit forms a tuning circuit. The tuning circuit can generate a plurality of control signals to tune the complex filter to a predetermined frequency. The tuning circuit can be turned off after a predetermined period.

### RELATED APPLICATION

This application claims the benefit of U.S. provisional application, titled Complex Filter Based on Leapfrog Lowpass Prototype with Mixed-Signal Automatic Tuning System, Ser. No. 60/778,222, filed on Mar. 2, 2006, the specification of which is incorporated herein in its entirety by this reference.

### BACKGROUND OF THE INVENTION

1. Field of the Invention

The present invention relates to receivers and in particular to low-IF (intermediate frequency) receivers.

2. Description of the Related Art

Receivers are commonly used in RF (radio frequency) signal transmission. In wireless communication field, the receivers are usually used to receive RF signals. The receivers convert these RF signals to desirable IF signals and transfer these IF signals to their destination where the IF signals are used. The receivers are widely employed in telecommunication, for example, use in wireless network access points.

The receivers (e.g., wide band receivers) typically are designed to process input signals with a wide range of input carrier frequencies. For example, television receivers may be capable of processing input television signals with carrier frequencies ranging from 55 MHz to 880 MHz. During the signal processing or transmission, noises and/or other undesirable signals may occur and affect the IF signals.

Hence, filters are required for receivers. The filter embedded into the receiver may filter out the noises or other undesirable signals as previously described. A tuning circuit typically is required to tune the filter to a desirable frequency. It is desirable if the tuning circuit can be turned off after tuning in order not to interfere with the operation of the filter. The filter usually can be configured differently to conform to different operating conditions. One popular configuration is an active-RC complex filter.

A cascade-pole method is often used to synthesize the active-RC complex filter. However, the disadvantage of the cascade-pole method is that the complex filter is sensitive to some circuit parameters such as resistance and capacitance. This disadvantage will greatly impair the performance of the receiver. In order to overcome the disadvantage, a filter synthesized from a leapfrog lowpass prototype network is used because it is well-known to be less sensitive to component variation.

It is thus desirous to have an apparatus and method that provides a complex filter with automatic tuning capabilities embedded in a receiver with high accuracy, large dynamic range, simple configuration and low power dissipation and at the same time without adding to the complexity of the receiver. It is to such apparatus and method the present invention is primarily directed.

### BRIEF SUMMARY OF THE INVENTION

In one embodiment, there is disclosed a complex filter with automatic tuning capabilities for filtering a complex signal. The complex signal has an imaginary component and a real component. The complex filter includes a first lowpass filter, a second lowpass filters, a plurality of resistors, an integrator, a comparator, and a digital unit. The first lowpass filter receives the imaginary component of the complex signal and generates a signal as an output signal of the complex filter. The second lowpass filter receives the real component of the complex signal. The plurality of resistors are coupled between the first and the second lowpass filters. The integrator receives a first reference voltage and generates an output signal. The comparator compares the output signal from the integrator with a second reference voltage and generates a digital signal according to a result of comparison. The digital unit receives the digital signal and generates a first control signal, a second control signal, a third control signal and a fourth control signal. The fourth control signal is delivered to the first and the second lowpass filters.

In yet another embodiment, there is disclosed a tuning system for a complex filter. The tuning system includes a tuning circuit, a transistor, and a final latch. The tuning circuit generates a latch up signal. The tuning circuit includes an integrator, a comparator, and a digital unit. The integrator receives a first reference voltage and generates an output signal. The comparator compares the output signal from the integrator with a second reference voltage and generates a digital signal. The digital unit receives the digital signal and generates a first control signal, a second control signal, a third control signal and a fourth control signal. The fourth control signal is used to tune the complex filter to a predetermined frequency. The transistor receives the latch up signal. The transistor is controlled by the latch up signal. The final latch receives the latch up signal and transfers the fourth control signal to the complex filter in a tuning mode and turns off the tuning circuit after a predetermined period.

In yet another embodiment, there is disclosed a receiver for processing a radio frequency (RF) signal. The receiver includes a bandpass filter, a low noise amplifier (LNA), two radio frequency-to-intermediate frequency (RF-IF) mixers, a complex filter, a variable gain amplifier (VGA) with an automatic gain control (AGC) loop, an analog-to-digital converter (ADC), and a digital circuit. The bandpass filter filters the RF signal. The LNA amplifies the filtered RF signal. The RF-IF mixers receive the amplified RF signal and convert the amplified RF signal to an IF signal. The IF signal is a complex signal and includes an imaginary component and a real component. The complex filter receives the IF signal and generates an analog signal. The complex filter is a BPF. The VGA amplifies the analog signal. The ADC converts the amplified analog signal to a digital signal for further processing. The digital circuit processes the digital signal from the ADC and transfers the digital signal to an external element.

In yet another embodiment, there is disclosed a method for automatically tuning a complex filter. The method includes the steps of generating a charge current, generating a voltage signal through charging and discharging a capacitor bank, comparing the voltage signal with a reference voltage, generating a digital signal based upon a result of comparison, generating a charge control signal, a discharge control signal, and a first switch control signal and a second switch control signal at a digital unit based upon the digital signal, and tuning the complex filter to a predetermined frequency through the second switch control signal from the digital unit.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a schematic diagram of characteristics of frequency transform of a complex filter and its lowpass prototype;

FIG. 2 is a block diagram of an exemplary complex filter consistent with the invention;

FIG. 3 is a block diagram of an exemplary tuning circuit for the complex filter in FIG. 2 consistent with the invention;

FIG. 4 is a block diagram of an exemplary digital unit of the tuning circuit in FIG. 3;

FIG. 5 is a schematic diagram of an exemplary capacitor bank in both the complex filter in FIG. 2 and the tuning circuit in FIG. 3;

FIG. 6 is a simplified block diagram of another exemplary tuning device for the complex filter in FIG. 2 consistent with the invention;

FIG. 7 is a waveform of four clock signals for the tuning circuit in FIG. 3;

FIG. 8 is a simplified diagram of the tuning code of the capacitor bank; and

FIG. 9 is a block diagram of an exemplary receiver consistent with the invention.

### DETAILED DESCRIPTION OF THE INVENTION

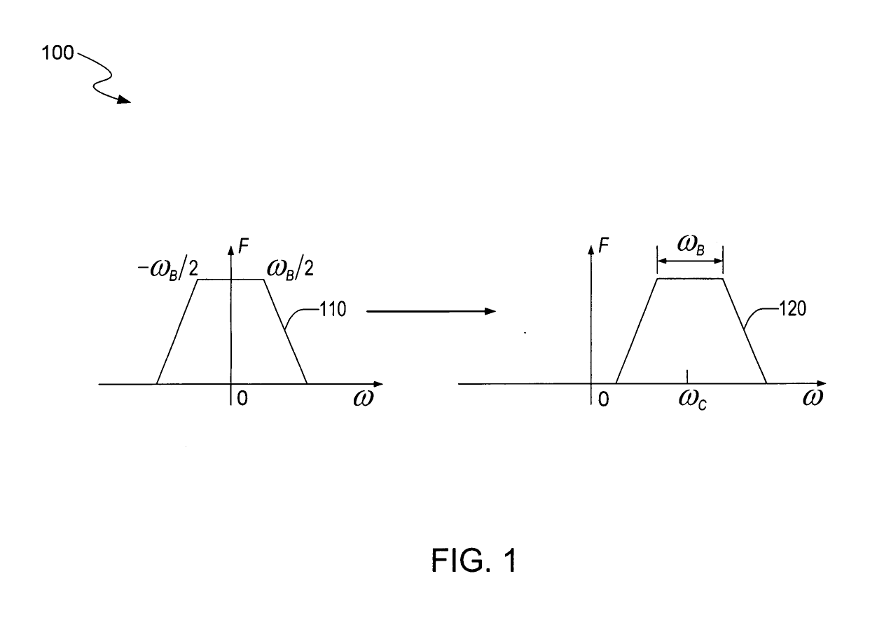

The invention provides direct synthesis of a complex filter from its leapfrog lowpass prototype. The direct synthesis of the complex filter from its leapfrog lowpass prototype makes the complex filter less sensitive to the tolerance of the component values. FIG. 1 is a schematic diagram 100 that illustrates characteristics of frequency transform of a complex filter and its lowpass prototype (a lowpass filter). Plot 110 illustrates the transfer function of the lowpass prototype whose bandwidth is ω_{B}. The cutoff frequencies of the lowpass prototype are −ω_{B}/2 and ω_{B}/2, respectively. Plot 120 depicts the transfer function of the complex filter. The transfer function of the complex filter can be shifted to a center frequency, compared with that of its lowpass prototype. The shift of the transfer function of the complex filter can be expressed by equation (1).
H_{C}(ω)=H_{L}(ω−ω_{C}) (1)

Wherein H_{C}(ω) is the transfer function of the complex filter, H_{L}(ω) is the transfer function of the lowpass prototype, and ad is the center frequency of the complex filter.

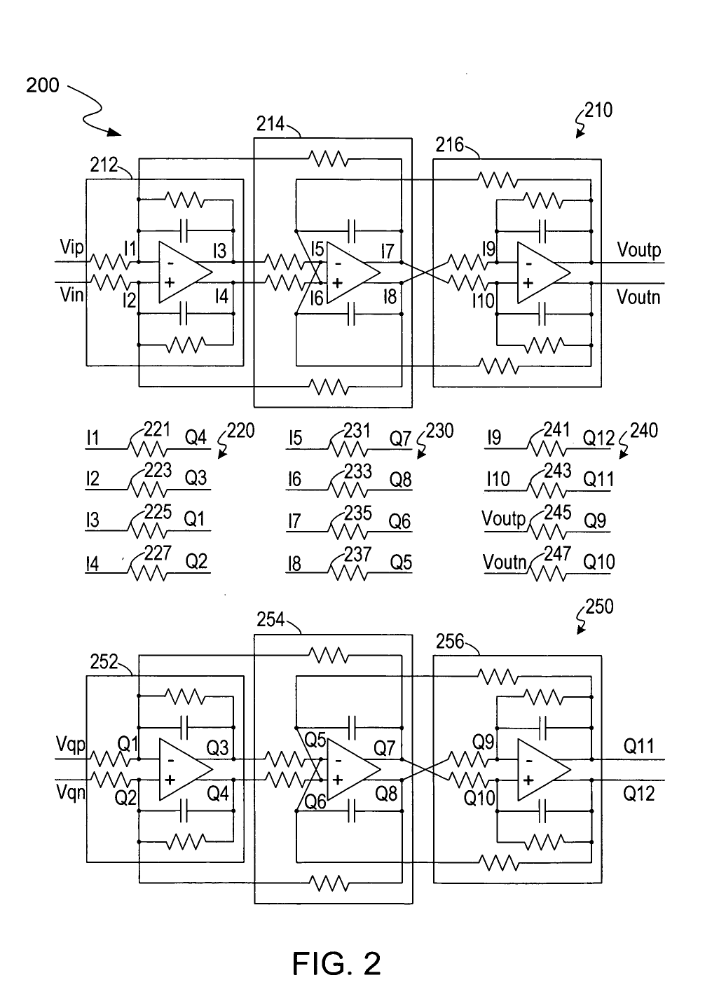

FIG. 2 illustrates a schematic diagram of an exemplary complex filter 200. The complex filter 200 can process a received IF signal according to different requirements from the corresponding applications. The complex filter 200 includes a first leapfrog lowpass filter 210, a plurality of resistors 230, 240 and 250, and a second leapfrog lowpass filter 250. In this embodiment, the complex filter 200 is a third-order leapfrog active-RC complex filter. The leapfrog lowpass filters 210 and 250 can be third-order leapfrog lowpass filters. Furthermore, the first third-order leapfrog lowpass filter 210 has the same architecture as the second third-order leapfrog lowpass filter 250. The plurality of resistors are coupled between the leapfrog lowpass filters 210 and 250 for frequency transform whose characteristics have been described previously in FIG. 1. Hence, the leapfrog lowpass filters 210 and 250 and the plurality of resistors 230, 240 and 250 are synthesized into the complex filter 200. The bandwidth and center frequency of the complex filter 200 may be equal to ω_{B} and ω_{C}, respectively.

In the complex filter 200, each of the third-order leapfrog lowpass filters 210 and 250 is composed of three integrators. Additionally, three groups of frequency transform resistors are needed to connect the first third-order leapfrog lowpass filter 210 to the second third-order leapfrog lowpass filter 260.

The complex filter 200 can receive two groups of input signals at its input terminals. The two groups of input signals consist of a real part (“I” component) and an imaginary part (“Q” component). In other words, both “I” and “Q” components can be separately supplied to the complex filer 200. In addition, an image usually is included in the IF signal. The image can interfere the processing and transmission of the IF signal such that the image needs to be filtered out.

The first third-order leapfrog lowpass filter 210 consists of three integrators 212, 214, and 216. In this embodiment, the output of the integrator 212 acts as the input of integrator 214 and the output of the integrator 214 serves as the input of the integrator 216. Each integrator is composed of an operational amplifier and some resistors and capacitive elements that usually surround the operational amplifier. Likewise, the second third-order leapfrog lowpass filter 250 is composed of three integrators 252, 254, and 256. Each of the integrators 252, 254, and 256 also consists of an operational amplifier and some resistors and capacitive elements.

For frequency transform, three groups of resistors 220, 230, and 240 are provided between the leapfrog lowpass filters 210 and 250. For example, the first group of resistors 220 is coupled between the integrators 212 and 252. The first group of resistors 220 includes four resistors 221, 223, 225, and 227. The resistor 221 is coupled between the inverting input terminal of the operational amplifier in the integrator 212 and the second output terminal of the operational amplifier in the integrator 252. The resistor 223 is coupled between the non-inverting input terminal of the operational amplifier in the integrator 212 and the first output terminal of the operational amplifier in the integrator 252. The resistor 225 is connected between the first output terminal of the operational amplifier in the integrator 212 and the inverting input terminal of the operational amplifier in the integrator 252. The resistor 227 is connected between the second output terminal of the operational amplifier in the integrator 212 and the non-inverting input terminal of the operational amplifier in the integrator 252.

Since the second group of resistors 230 and the third group of resistors 240 have the similar configuration with the first group 220, the symbols for the second group 230 and the third group 240 are similar to that for the first group 220. Hence, the description of the similar functions and connections of the above-mentioned components will be omitted herein for clarity.

Each capacitive element in FIG. 2 can be a capacitor bank that consists of a plurality of capacitors coupled in parallel. The capacitance of the capacitor bank is variable. The configuration of the capacitor bank will be described in detail below. All of the capacitive elements in FIG. 2 are from the same type for good match and tuning accuracy. Additionally, all of the resistors can also be selected from the same type of resistors to enable the complex filter 200 to have the good match and tuning accuracy.

$${R}_{T} = \frac{1}{{ω}_{C} {C}_{INT}} \qquad ( 2 )$$

Wherein R_{T} is the resistance of the frequency transform resistors, C_{INT} is the capacitance of the capacitors in the integrators, and ω_{C} is the center frequency of the complex filter 200.

The third-order (3rd-order) leapfrog active-RC complex filter 200 in FIG. 2 is only for illustrative purpose. Those skilled in the art will appreciate that the complex filter 200 can be modified to use other higher order leapfrog filters, for example, the fourth-order, the fifth-order or the Nth-order leapfrog filters. When the Nth-order leapfrog filters are used, N groups of resistors are needed for frequency transform.

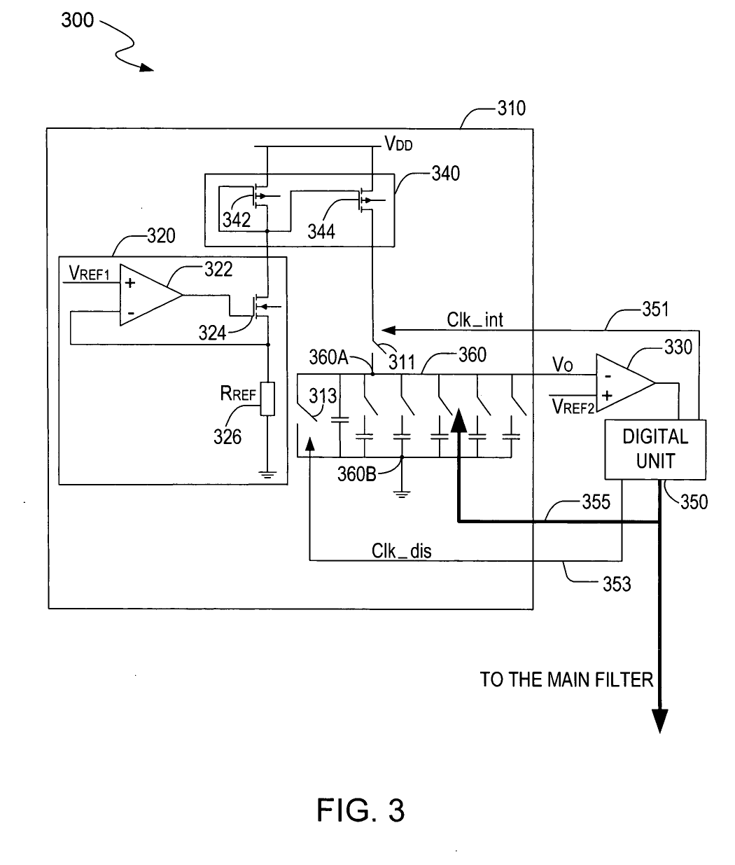

FIG. 3 is a schematic diagram of a tuning circuit 300 for the complex filter 200 in FIG. 2. The tuning circuit 300 can tune the complex filter 200 to a desirable frequency. The tuning circuit 300 can include an integrator 310, a comparator 330, and a digital unit 350. The integrator 310 is composed of a current source 320, a current mirror 340, and a capacitor bank 360. The integrator 310 serves as a reference filter and the complex filter 200 acts as a main filter.

The current source 320 may include an operational amplifier 322, a NMOS transistor 324, and a reference resistor 326. The operational amplifier 322, the NMOS transistor 324, and the reference resistor 326 forms a ‘constant-G_{M}’ architecture. The reference resistor 326 can be the same type of resistor as those in the complex filter 200 in FIG. 2. The amplifier 322 receives a reference voltage V_{REF1} generated internally by the tuning circuit 300. The reference voltage can be converted to a reference current flowing through the NMOS transistor 324 and the reference resistor 326 when the NMOS transistor 324 is turned on. The reference current is given by equation (3).

$${I}_{REF} = {V}_{REF} {G}_{M} = \frac{{V}_{REF 1}}{{R}_{REF}} \qquad ( 3 )$$

Wherein I_{REF} is the current flowing through the reference resistor 326, V_{REF1} is the reference voltage of the operational amplifier 322, and R_{REF} is the resistance of the reference resistor 326.

The current mirror 340 is composed of a first PMOS transistor 342 and a second PMOS transistor 344. The reference current can be mirrored by the current mirror 340. As a result, the current mirror 340 can output a charge current that can be used to charge the capacitor bank 360 in a charge mode.

The capacitor bank 360 is equipped with a charge switch 311 and a discharge switch 313. The capacitor bank 360 is composed by a plurality of capacitors and switches whose connection will be further described below. The capacitor bank 360 has two ends 360A and 360B. The end 360B is coupled to the ground. The charge switch 311 is coupled between a drain terminal of the PMOS transistor 344 and the end 360A of the capacitor bank 360. When the charge switch 311 is turned on under control of a control signal on path 351, the capacitor bank 360 will be charged and generate a higher output signal at the end 360A expressed by equation (4). In addition, the capacitors included in the capacitor bank 360 can be turned on or off under control of a tuning code (tuning sequence) from the digital unit 350 on path 355. In one embodiment, the tuning code is a 5-bit digital signal used to control all capacitors in the capacitor bank 360. Hence, the capacitance of the capacitor bank 360 can vary when the tuning code on path 355 changes.

$${V}_{O} = \frac{{I}_{REF} t}{{C}_{BANK}} = \frac{{V}_{REF 1}}{{R}_{REF} {C}_{BANK}} t \qquad ( 4 )$$

Wherein V_{O} is the output signal of the capacitor bank 360, I_{REF} the charge current provided by the current mirror 340, C_{BANK} is the capacitance of the capacitor bank 360, V_{REF1} is the reference voltage of the amplifier 322, R_{REF} is the resistance of the reference resistor 326, and t is the charging period of the capacitor bank 360.

The discharge switch 313 is coupled between the ends 360A and 360B of the capacitor bank 360. When the capacitor bank 360 operates in a discharge mode, the discharge switch 313 is turned on under control of a control signal on path 353. As a result, the capacitor bank 360 is short-circuited. Consequently, the capacitor bank 360 will be discharged to zero in the discharge mode.

As shown in equation (4), the output signal of the integrator 310 (i.e., the output signal of the capacitor bank 360) includes a RC time constant of the reference filter. Therefore, the output signal of the integrator 310 can be considered as a function of the time constant of the reference filter, and the reference filter can be tuned by changing the tuning code of the capacitor bank 360. The tuning accuracy of the tuning circuit 300 is determined by the bit number of the capacitor bank 360. If the bit number is n, the tuning accuracy is (½)ⁿ. In this embodiment, a 5-bit system is taken as an example.

The output signal of the integrator 310 (i.e., the output signal of the capacitor bank 360) V_{O} is delivered to the inverting input terminal of the comparator 330, and is compared with a reference voltage V_{REF2}. When the output signal of the integrator 310 V_{O} is smaller than the reference voltage V_{REF2}, the comparator 330 will generate “1”. When receiving the “1” from the comparator 330, the digital unit 350 can increase the 5-bit tuning code until V_{O} is not smaller than the reference voltage V_{REF2}. Conversely, when the output signal of the integrator 310 V_{O} is larger than the reference voltage V_{REF2}, the comparator will generate “0”. As a result, the digital unit 350 will decrement the 5-bit tuning code till V_{O} is not larger than V_{REF2}. Repeat of the above process can ensure that V_{O} is finally close to V_{REF2}. In this tuning action, the accuracy is determined by the bit number that is (½)⁵ in this embodiment.

The digital unit 350 generates two control signals to control the switches 311 and 313. The control signals on path 351 and path 353 are clock signals. After every comparison between V_{O} and V_{REF2}, the output signal of the integrator 310 will be discharged under control of the control signal on path 353. Then the control signal on path 351 will start charging of the capacitor bank 360. In addition, the digital unit 350 employs the new tuning code to regulate the capacitance of the capacitor banks in the integrator 310 and the complex filter 200. The tuning code on path 355 can also be used to control the capacitor banks in the complex filter 200.

Those skilled in the art will appreciate that the capacitors in the capacitor bank 360 can be selected the same type of those in the complex filter 200 in FIG. 2 for the good match and tuning accuracy. Those skilled in the art will also appreciate that the tuning circuit 300 can be incorporated into the complex filter 200. In other words, the tuning circuit 300 and the complex filter 200 can be embedded into one integrated circuit (IC).

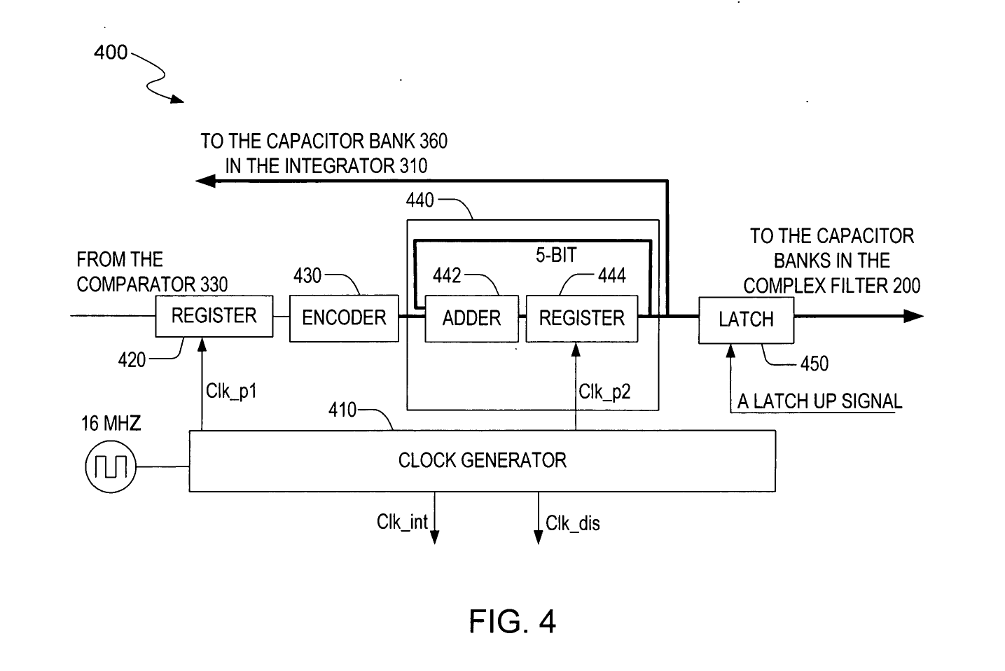

FIG. 4 is a block diagram of an exemplary digital unit 400 of the tuning circuit 300 in FIG. 3. The digital unit 400 includes a clock generator 410, a register 420, an encoder 430, a counter 440, and a latch 450. The counter 440 is composed of an adder 442 and a register 444.

Activated by a main clock, the clock generator 410 can generate different clock signals to control the charge switch 311 and the discharge switch 313 of the integrator 310 shown in FIG. 3. The clock generator 410 can also generate a clock signal Clk_p1 to control the registers 420 and another clock signal Clk_p2 to control the register 444.

The output signal “1” or “0” from the comparator 330 can be stored into the register 420. Under control of the clock signal Clk_p1, these stored signals can be delivered to the encoder 430. The encoder 430 can encode these signals into a code series according to a predetermined algorithm. The encoder 430 can convert the 1-bit output signal from the comparator 330 into a 5-bit code. For example, “1” from the comparator 330 can be encoded into “00001” by the encoder 430. “0” from the comparator 330 can be encoded into “11111”, that is, the complementary word of “−1” by the encoder 430.

The counter 440 calculates the increment or decrement of the tuning code based upon the comparison done by the comparator 330. In operation, the 5-bit code from the encoder 430 is sent to the adder 442. The adder 442 can sum up this 5-bit code with an output code from the register 444 and produce a calibrated code (an updated code). The calibrated code is then stored in the register 444. Under control of the clock signal Clk_p2, the output of the counter 440 (i.e., the output code from the register 444) can be provided to the capacitor bank 360 in the integrator 310. Acting as a control code, the output of the counter 440 can control the switches in the capacitor bank 360, turning them on or off. Then the integrator 310 will generate a new output signal used to compare with the reference voltage of the comparator 330. The above process will repeat until the tuning action is completed. Under control of the clock signal Clk_p2, the calibrated code is also sent to the latch 450. The latch 450 is controlled by a latch up signal that is generated internally by the tuning circuit 400. The calibrated code will be latched in the latch 450 under control of the latch up signal when the tuning action completes. In other words, the calibrated code will remain in the latch 450 until a recalibration signal is generated. The tuning code (i.e., the calibrated code) will be delivered to the capacitor banks in the complex filter 200 to determine their capacitance.

The tuning action can be completed after a certain time. If the bit number of the capacitor bank 360 in the tuning circuit 300 is N, the longest time to tune the complex filter 200 will be 2ˆN cycles. Hence, the tuning action can be automatically completed after the 2ˆcycles.

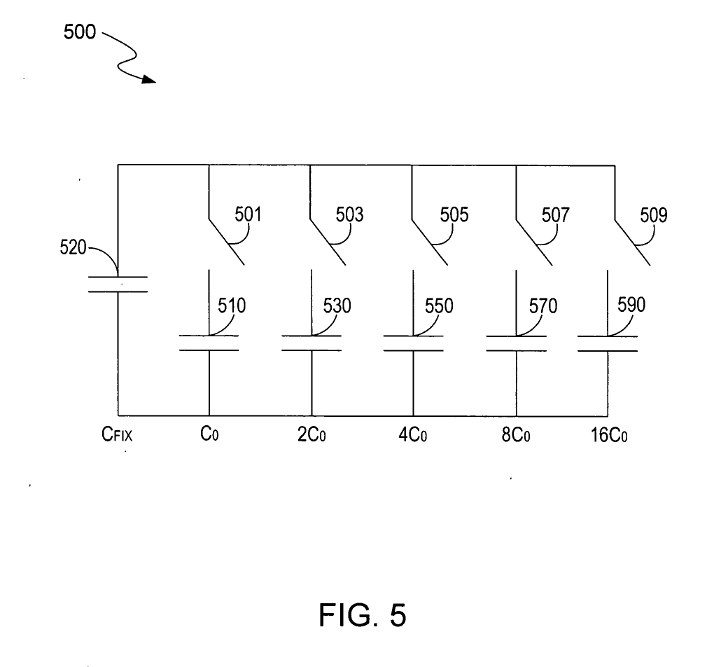

FIG. 5 is a schematic diagram of an exemplary capacitor bank 500 in both the complex filter 200 in FIG. 2 and the tuning circuit 300 in FIG. 3. As described previously, the capacitor banks in the complex filter 200 and the tuning system 300 must be the same for the good match and tuning accuracy. The capacitor bank 500 is composed of a fixed capacitor 520, and switched capacitors 510, 530, 550, 570, and 590. The switched capacitor 510 is connected in serial with a switch 501. Similarly, the switched capacitors 530, 550, 570 and 590 are connected in serial with switches 503, 505, 507 and 509, respectively. The fixed capacitor 520 is coupled in parallel with any or combination of the switched capacitors 510, 530, 550, 570, and 590 when the corresponding switch(s) is tuned on.

The RC time constant in the complex filter 200 described previously can have an error, for example, ±α% due to different factors. These factors can include the signal processing, temperature or other issues. In this situation, the capacitance in the capacitor bank 500 can be determined by equations (5) and (6) below.
C_{FIX}=C_{N}(1−α%) (5)
C_{FIX}+(C₀+2C₀+ . . . +16C₀)=C_{N}(1+α%) (6)

Wherein C_{FIX} is the capacitance of the fixed capacitor 520, α% is the error of the RC time constant in the complex filter 200, and C_{N} is the nominal value of the capacitor banks that is the capacitance calculated under the typical situation after the synthesis. C₀, 2C₀, 4C₀, 8C₀, and 16C₀ are the capacitance of the switched capacitors 510, 530, 550, 570, and 590, respectively.

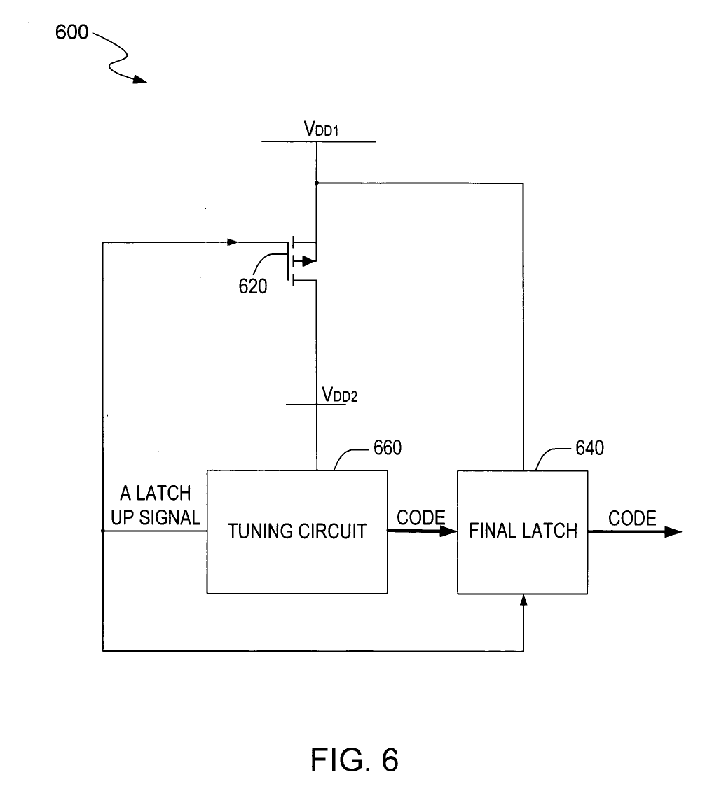

FIG. 6 is a simplified block diagram of another exemplary tuning device 600. The tuning device 600 consists of a PMOS transistor 620, a final latch 640, and a tuning circuit 660. Since the tuning circuit 660 is similar to the tuning circuit 300, the similar description of configuration and function of the turning circuit 660 will be omitted herein for clarity.

In FIG. 6, a latch up signal generated by the tuning circuit 660 is used to control the PMOS transistor 620 and the final latch 640. The source terminal of the PMOS transistor 620 can receive a power supply V_{DD1} from an external electrical source. The drain terminal of the PMOS transistor 620 can provide another power supply V_{DD2} to the tuning circuit 660. In other words, the power supply V_{DD2} is the operational voltage of the tuning circuit 660. Hence, the PMOS transistor 620 serves as the switch controlled by the latch up signal as previously described. When the latch up signal is “0”, the PMOS transistor 620 is tuned on so that the power supplies V_{DD1} and V_{DD2} are short. In this situation, the tuning circuit 660 operates normally. When the latch up signal becomes “1” due to the completion of the tuning action, the PMOS transistor 620 will be turned off. Hence, the power supply V_{DD1} is open from the power supply V_{DD2}. In this condition, the final latch 640 can store the final tuning code for the capacitor banks in the complex filter 200.

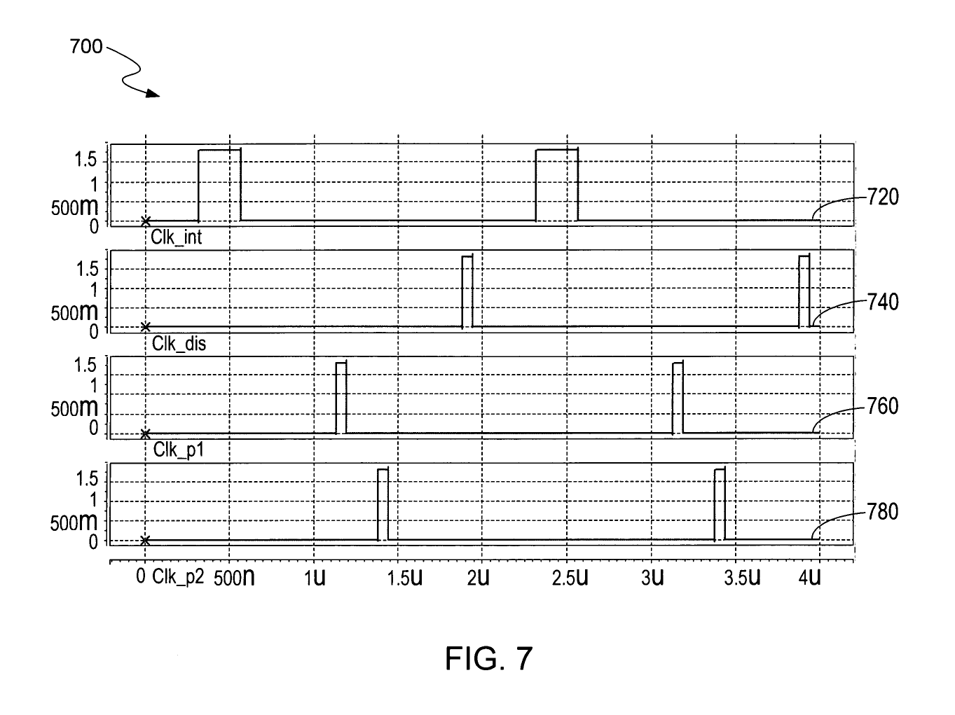

FIG. 7 is a waveform 700 of four clock signals for the digital unit 400 and the tuning circuit 300 in FIG. 3. These four clock signals are produced by the clock generator 410 in FIG. 4 to control the timing in the tuning circuit 300. The clock signals shown by plots 720 and 740 are used to control the charge and the discharge of the integrator 310, respectively. The clock signals illustrated by plots 760 and 780 are used to control the registers 420 and 444 in the digital unit 400.

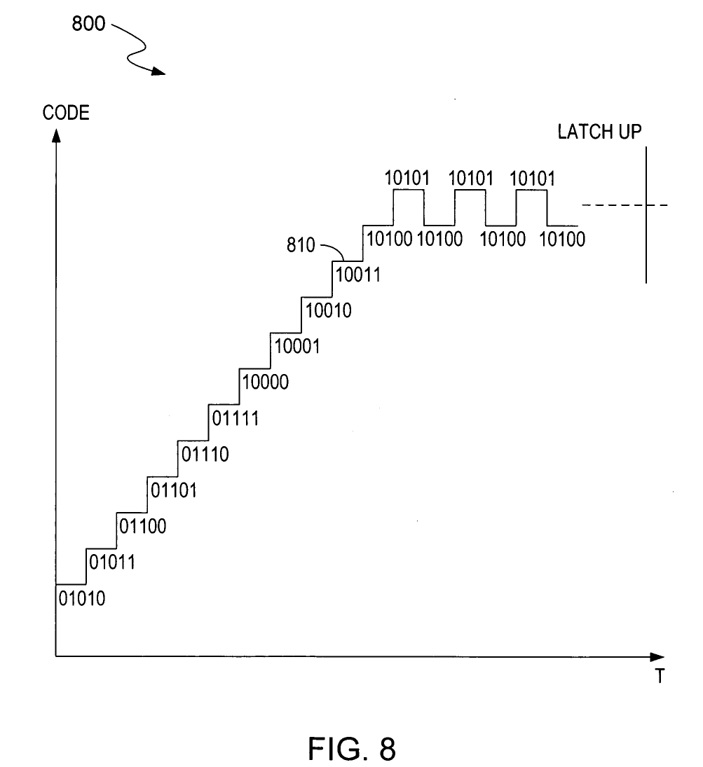

FIG. 8 is a simplified diagram 800 that illustrates the tuning code (the tuning sequence) of the capacitor banks in the complex filter 200 and the tuning circuit 300. As described previously, a 5-bit tuning code of the capacitor bank is used herein for illustration shown by plot 810. The tuning code can continue to increase during the tuning process until the tuning code turns into “up and down” when the tuning circuit 300 has reached its expected accuracy. The tuning circuit 300 will be turned off after a certain time, for example, T to store the final tuning code.

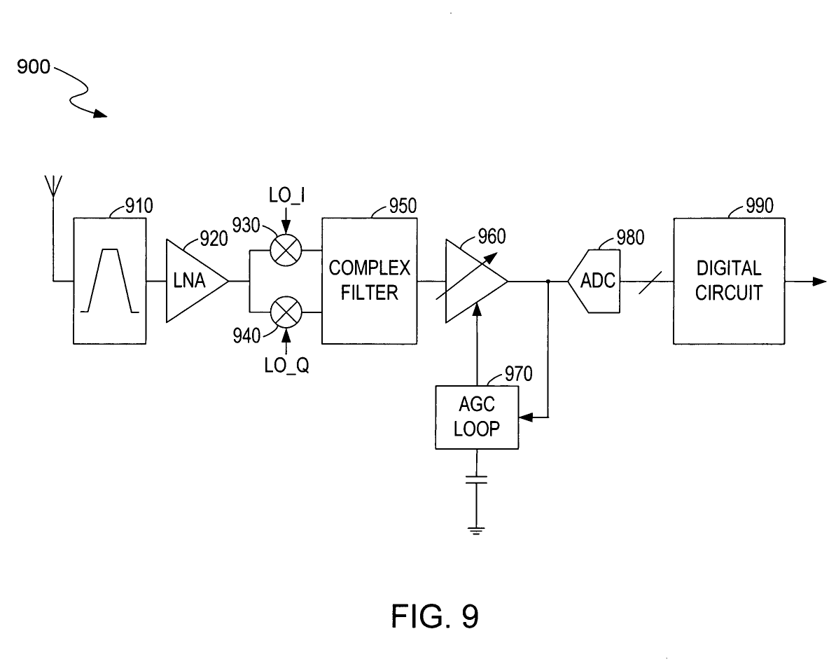

Turing to FIG. 9, a receiver 900 can employ the aforementioned approaches and technologies in the above embodiments. The receiver 900 consists of a bandpass filter (BPF) 910, a low noise amplifier (LNA) 920, two radio frequency-to-intermediate frequency (RF-IF) mixers 930 and 940, a complex filter 950, a variable gain amplifier (VGA) 960, an automatic gain control (AGC) loop 970, an analog-to-digital converter (ADC) 980, and a digital circuit 990. In this embodiment, only necessary elements are illustrated in FIG. 9 for clarity. Those skilled in the art will appreciate that some accessorial and peripheral elements are also required for the configuration of the receiver 900.

The receiver 900 can receive a RF signal via an external antenna. After being received, the RF signal can be filtered by the BPF 910 and then sent to the LNA 920. After being amplified by the LNA 920, the RF signal is sent to the RF-IF mixers 930 and 940. The RF-IF mixers 930 and 940 can down-convert the amplified RF signal from a higher radio frequency to an intermediate frequency. The frequency ranges of the RF signal and the IF signal are variable according to users' different requirements. The RF-IF mixers 930 and 940 can divide the IF signal into two parts, an imaginary part and a real part. In one embodiment, the RF-IF mixers 930 and 940 can be quadrature mixers.

The complex filter 950 is also a bandpass filter. The complex filter 950 can employ the aforementioned methods and technologies to filter out the image from the IF signal. After filtered by the complex filter 950, the IF signal is sent to the VGA 960. With the AGC loop 970, the VGA 960 can provide an appropriate gain. After being amplified by the VGA 960, the amplitude of the analog signal can be optimal for further processing. The optimal analog signal is then sent to the ADC 980 where the signal is converted to a digital signal. The digital signal can be received and processed by the digital circuit 990. The processed signal will be further sent to external elements as a source signal.

In operation, in order to tune a complex filter to a desirable frequency, a tuning circuit is required. During the power up procedure, the complex filter 200 filters the image out from the IF signal and is tuned to a desirable frequency under control of the tuning circuit 300. In the tuning mode, a digital unit in the tuning circuit 300 generates a charge control signal, a discharge control signal and a first N-bit signal to control the capacitor bank 360 in the integrator 310 included in the tuning circuit 300. The digital unit also generates a second N-bit signal to control the capacitor banks in the complex filter 200.

In the integrator 310, a charge current is generated by the current source 320 and the current mirror 340. Controlled by the charge control signal, the switch 311 will be turned on so that the charge current can charge the capacitor bank 360. Since the switches in the capacitor bank are tuned on or off under control of the N-bit signal, the capacitance of the capacitor bank 360 can vary. Additionally, when the switch 313 is tuned on under control of the discharge control signal, the capacitor bank 360 will be discharged.

The variance of the output signal of the integrator 310 results in different digital signals to be delivered to the digital unit 400. The digital unit 400 stores the digital signals in the register 420. The encoder 430 reads the digital signals according to a clock signal and encodes the digital signals into an N-bit code. The adder 442 can calculate the increment or decrement of the N-bit code through adding the output of the counter 440 to the N-bit code from the encoder 430. The sum of these two codes is stored into the register 444. Under control of another clock signal, the sum is read out. The sum is used to control the capacitor bank 360 in the integrator 310. The sum is also sent to the capacitor banks in the complex filter 200 after a latch up signal is received by the latch 450. In this condition, the tuning action of the complex filter 200 is completed after a predetermined period.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims. Furthermore, although elements of the invention may be described or claimed in the singular, the plural is contemplated unless limitation to the singular is explicitly stated.

What is claimed is:

1. A complex filter with automatic tuning capabilities for filtering a complex signal, the complex signal having an imaginary component and a real component, the complex filter comprising:
a first lowpass filter capable of receiving the imaginary component of the complex signal and generating a signal as an output signal of the complex filter;
a second lowpass filter capable of receiving the real component of the complex signal;
a plurality of resistors coupled between the first and the second lowpass filters;
an integrator capable of receiving a first reference voltage and generating an output signal;
a comparator capable of comparing the output signal from the integrator with a second reference voltage and generating a digital signal according to a result of comparison; and
a digital unit capable of receiving the digital signal and generating a first control signal, a second control signal, a third control signal and a fourth control signal, the fourth control signal being delivered to the first and the second lowpass filters.

2. The complex filter of claim 1, wherein each of the first and the second lowpass filters including a plurality of integrators, and each integrator consisting of an operational amplifier and a plurality of resistors and capacitive elements.

3. The complex filter of claim 2, wherein each capacitive element in the plurality of integrators being a capacitor bank and the capacitance of each capacitor bank being adjustable under control of the fourth control signal from the digital unit.

4. The complex filter of claim 1, wherein the first and the second lowpass filters being Nth-order leapfrog lowpass filters, and the plurality of resistors including N groups of resistors.

5. The complex filter of claim 1, wherein the integrator further comprising:
a current source capable of receiving the first reference voltage and converting the first reference voltage into a current;
a current mirror capable of receiving the current and generating a mirrored current, the mirrored current being a charge current;
a capacitor bank, the capacitor bank including a fixed capacitor and a plurality of switched capacitors, the plurality of switched capacitors being controlled by the third control signal from the digital unit;
a first switch coupled between the current mirror and the capacitor bank, the first switch being controlled by the first control signal from the digital unit; and
a second switch coupled in parallel with the capacitor bank, the second switch being controlled by the second control signal from the digital unit.

6. The complex filter of claim 1, wherein the digital unit further comprising:
a clock generator capable of generating a first clock signal and a second clock signal;
a register capable of storing the digital signal from the comparator and outputting the digital signal under control of the first clock signal;
an encoder capable of encoding the digital signal from the register into a first code;
a counter capable of updating the first code from the encoder and generating a second code to the integrator; and
a latch capable of receiving the second code and generating the fourth control signal to the complex filter.

7. The complex filter of claim 6, wherein the counter further comprising:
an adder capable of adding the first code to the second code and generating a sum; and
a register capable of storing the sum from the adder and updating the second code under control of the second clock signal.

8. A tuning system for a complex filter, the tuning system comprising:
a tuning circuit capable of generating a latch up signal, the tuning circuit including:
an integrator capable of receiving a first reference voltage and generating an output signal;
a comparator capable of comparing the output signal from the integrator with a second reference voltage and generating a digital signal; and
a digital unit capable of receiving the digital signal and generating a first control signal, a second control signal, a third control signal and a fourth control signal, the fourth control signal being capable of tuning the complex filter to a predetermined frequency;
a transistor receiving the latch up signal, the transistor being controlled by the latch up signal; and
a final latch capable of receiving the latch up signal and transferring the fourth control signal to the complex filter in a tuning mode and turning off the tuning circuit after a predetermined period.

9. The tuning system of claim 8, wherein the integrator further comprising:
a current source capable of receiving the first reference voltage and converting the first reference voltage into a current;
a current mirror capable of receiving the current and generating a mirrored current, the mirrored current being a charge current;
a capacitor bank, the capacitor bank including a fixed capacitor and a plurality of switched capacitors, the plurality of switched capacitors being controlled by the third control signal from the digital unit;
a first switch coupled between the current mirror and the capacitor bank, the first switch being controlled by the first control signal from the digital unit; and
a second switch coupled in parallel with the capacitor bank, the second switch being controlled by the second control signal from the digital unit.

10. The tuning system of claim 8, wherein the digital unit further comprising:
a clock generator capable of generating a first clock signal and a second clock signal;
a register capable of storing the digital signal from the comparator and outputting the digital signal under control of the first clock signal;
an encoder capable of encoding the digital signal from the register into a first code;
a counter capable of updating the first code from the encoder and generating a second code to the integrator; and
a latch capable of receiving the second code and generating the fourth control signal to the final latch.

11. The tuning system of claim 10, wherein the counter further comprising:
an adder capable of adding the first code to the second code and generating a sum; and
a register capable of storing the sum from the adder and updating the second code under control of the second clock signal.

12. A receiver for processing a radio frequency (RF) signal, comprising:
a bandpass filter (BPF) capable of filtering the RF signal;
a low noise amplifier (LNA) capable of amplifying the filtered RF signal;
two radio frequency-to-intermediate frequency (RF-IF) mixers capable of receiving the amplified RF signal and converting the amplified RF signal to an IF signal, the IF signal being a complex signal and including an imaginary component and a real component;
a complex filter capable of receiving the IF signal and generating an analog signal, the complex filter being a BPF;
a variable gain amplifier (VGA) with an automatic gain control (AGC) loop capable of amplifying the analog signal;
an analog-to-digital converter (ADC) capable of converting the amplified analog signal to a digital signal for further processing; and
a digital circuit capable of processing the digital signal from the ADC and transferring the digital signal to an external element.

13. The receiver of claim 12, wherein the complex filter further comprising:
a first lowpass filter capable of receiving the imaginary component of the IF signal and generating a signal as an output signal of the complex filter;
a second lowpass filters capable of receiving the real component of the IF signal; and
a plurality of resistors coupled between the first and the second lowpass filters.

14. The receiver of claim 13, wherein each of the first and the second lowpass filters including a plurality of integrators, and each integrator consisting of an operational amplifier and a plurality of resistors and capacitive elements.

15. The receiver of claim 14, wherein each capacitive element in the plurality of integrators being a capacitor bank and the capacitance of the capacitor bank being adjustable.

16. The receiver of claim 13, wherein the first and the second lowpass filters being Nth-order leapfrog lowpass filters, and the plurality of resistors including N groups of resistors.

17. The receiver of claim 12, wherein the digital circuit further comprising:
a clock generator capable of generating a first clock signal and a second clock signal;
a register capable of storing the digital signal from the ADC and outputting the digital signal under control of the first clock signal;
an encoder capable of encoding the digital signal from the register into a first code;
a counter capable of updating the first code from the encoder and generating a second code; and
a latch capable of transferring the second code to the external element.

18. The receiver of claim 17, wherein the counter further comprising:
an adder capable of adding the first code to the second code and generating a sum; and
a register capable of storing the sum from the adder and updating the second code under control of the second clock signal.

19. A method for automatically tuning a complex filter, comprising the steps of:
(a) generating a charge current;
(b) generating a voltage signal through charging and discharging a capacitor bank;
(c) comparing the voltage signal with a reference voltage;
(d) generating a digital signal based upon a result of the comparison;
(e) generating a charge control signal, a discharge control signal, a first switch control signal, and a second switch control signal at a digital unit based upon the digital signal; and
(f) tuning the complex filter to a predetermined frequency through the second switch control signal from the digital unit.

20. The method of claim 19, wherein the step of (b) comprising:
charging the capacitor bank by the charge current under control of the charge control signal; and
discharging the capacitor bank under control of the discharge control signal.

21. The method of claim 19, wherein the step of (e) comprising:
storing the digital signal;
reading the stored digital signal under control of a first clock signal;
encoding the read digital signal into a code;
updating the code; and
generating the first switch control signal based upon the updated code.

22. The method of claim 21, wherein the step of (e) further comprising:
latching the first switch control signal under control of a latch up signal; and
generating the second switch control signal.

23. The method of claim 19, wherein the step of (f) comprising:
tuning the complex filter to the predetermined frequency in a tuning mode; and
turning off the tuning mode after a predetermined period.
